(19) United States
(12) Patent Application Publication
(10) Pub. No.: US 2007/0023606 A1
(43) Pub. Date: Feb. 1, 2007

(54) Christmas tree stand with foot actuated clamp

(76) Inventor: Ralf Zimmermann, San Clemente, CA (US)

Correspondence Address: PATENT LAW & VENTURE GROUP, 2424 S.E. BRISTOL, SUITE 300, NEWPORT BEACH, CA, 92660, US

(21) Appl. No.: 11/192,247

(22) Filed: Jul. 27, 2005

(51) Int. Cl. F16M 13/00

(52) U.S. Cl. 248/523

(57) ABSTRACT

A clamp actuator engages a moving jaw at one end of a sliding bar. A fixed jaw is immovably mounted in opposition to the moving jaw. A lever presses a drive gate against the bar to move it forward with each stroke of the lever. Clamping surfaces are vertically staggered and engage a tree trunk or similar workpiece to clamp it in place. The action is horizontal so as to avoid interference with workpiece elements above the clamp. The clamp may be established within a basin or bowl containing water so as to accommodate a Christmas tree.

### BACKGROUND

1. Field of the Present Disclosure

This disclosure relates generally to stands utilized for supporting an elongate object in an upright attitude, and more particularly to such a stand useful for mounting a Christmas tree and securing it by foot actuation of a lever action clamp.

2. Description of Related Art

Thurner et al., U.S. 2002/0005466, discloses an invention that relates to a stand for clamping rod-shaped parts, in particular Christmas trees. The stand has a tensioning device and a holding device with a number of holding elements which can be pivoted from a holding position into a release position and are prestressed in the release position by respective springs. At least one force transmission element is provided, which is guided on the holding elements and can be tensioned by means of the tensioning device. The holding elements and/or the force transmission element are/is, at least in a region in which the force transmission element is guided on the holding elements, designed in such a manner that, when relative movement takes place between the holding elements and the force transmission element, the latter slides with reduced friction on the holding elements. The springs are integrated in the respective holding elements, and the holding elements consist of a slidable plastic. Thurner, U.S. 2002/0130242, discloses an invention that relates to a stand for holding bar-like components, especially on Christmas trees, having a socket element and a clamping and holding system, a centering system being provided for centering the bar-like component, having at least one flexible element, which reaches radially into a socket opening of the socket element so that a centering action with respect to a center point of the stand is produced on the bar-like component when introduced into the socket element. Love, U.S. Pat. No. 2,896,293, discloses an over center locking clamp, a base, a fixed jaw contiguous to the base, a moveable jaw hingedly connected to the base, a link pivotally connected to the moveable jaw, a lever hingedly connected to the base and pivotally connected to the link for moving the moveable jaw, a handle on one end of the lever for actuating the lever by hand, the jaws having a shape to clampingly engage a member being held therebetween, a heel engaging pad on the opposite end of the lever, and a foot engaging pad on the lever arranged forwardly of the heel engaging pad for actuating the lever by foot. Kuhnley, U.S. Pat. No. 4,699,347. discloses a tree stand, as for Christmas trees and the like, having in its preferred form a circular base with three legs extending upward in tripod form to an apex where a clamping mechanism is located. A ball is securely held between a clamp base located atop one leg, termed the socket leg, and a clamp top; the clamp top being located at the upper end of a clamp arm, an elongated member which pivots on the socket leg and whose lower end is spring biased away from the socket leg, thus forcing the clamp top upon the ball. The clamp, and thus the ball, is temporarily released by foot pressure on the lower end of the clamp arm, allowing alignment of the tree. The ball, with an attached tapered mating groove housing, is removably connected to a tree bracket having a tapered plate attached thereto. The tree bracket itself is laterally curved with protruding spikes formed on its inner surface, and is strapped to the side of the trunk to hold the tree securely. The tree stand may be reduced in size for storage. Foster, U.S. Pat. No. 4,850,137, discloses a cut plant watering device which allows watering of the plant in a container and facilitates removal of the water from the container. In particular in the combined use of a suction bulb funnel and tube in combination is described wherein the bulb is squeezed such that water replaces air in a chamber inside the bulb, which is then separately thrown away. The cut plant can be a Christmas tree. Krinner, U.S. Pat. No. 5,114,113, discloses a Christmas-tree stand that features a foot-piece with a connected holder to which fastening components are attached. In the example case, these components are swinging clamps which are pressed against the outer surface of the tree trunk by a clamping device. The pressure of the clamping device is applied to the fastening components via a steel cable for example, which encircles them and is attached to the clamping device. The cable moves the fastening components toward the trunk with adjustable and evenly distributed force. Roy, U.S. Pat. No. 5,375,808, discloses a Christmas tree stand that has a base having a jaw assembly with a bottom for slidably engaging a tree trunk and a bar, above the bottom of the jaw assembly, for forcibly clamping the trunk laterally between the bar and jaw assembly. The bar member is preferably relatively stiff but resiliently bendable, and pivotally attached to the base so as to be movable selectively toward or away from the tree trunk laterally. The bar is lockable in variable positions relative to the base in tight engagement with trunks of differing diameters. After the bar is locked, the tree is easily straightened by grasping an upper portion of the trunk and moving it laterally, causing the bottom of the trunk to slide laterally across the bottom of the jaw assembly while the bar acts as a fulcrum about which the trunk pivots. Schmitz, U.S. Pat. No. 6,854,700, discloses a foot support for profiled sections that has a base member; a receptacle for the profiled section arranged in the base member; and several tensioning levers having a horizontal pivot axis and arranged about an axis of symmetry. The tensioning levers are pivotable between a rest position and a clamping position about the horizontal pivot axis. The tensioning levers have a lower lever arm positioned below the horizontal axis and an upper lever arm positioned above the horizontal pivot axis. A foot-actuated actuating element that acts on a force-transmitting element, acting on the tensioning levers for moving them into the clamping position, is provided. The force-transmitting element is a vertically adjustable ring that, when carrying out a downward movement, contacts the lower lever arms of the tensioning levers such that the lower lever arms are pivoted outwardly and the upper lever arms are pivoted inwardly into the clamping position.

The prior art teaches several clamping type tree stands. However, the prior art fails to teach a clamping stand with a linear, spring-loaded clamp that is easily actuated by foot pressure and applies extremely powerful clamping action. The present disclosure distinguishes over the prior art providing heretofore unknown advantages as described in the following summary.

### SUMMARY

This disclosure teaches certain benefits in construction and use which give rise to the objectives described below.

A clamping apparatus is mounted on a platform which would normally be supported on a floor surface. The platform supports a linear clamp actuator, a container having an open top, and a fixed and immovable jaw. An opposing movable jaw is engaged with the clamp actuator so as to be moved toward the fixed jaw in response to pumping action applied to a drive lever of the clamp actuator. The fixed and movable jaws are positioned within the container so that the clamp may be used to support a Christmas tree in water held in the container. An upwardly projecting spike may be fixed to a bottom of the container between the jaws for anchoring the Christmas tree. A linear bar is slidably mounted within a lever housing and moves above and in parallel to the surface of the platform. The clamp actuator provides, within the lever housing, a drive gate and a restrictor gate, the drive gate engaged with the bar and the drive lever for moving the bar in a jaw-converging direction in response to a depression of the drive lever, the restrictor gate engaged with the bar and a release lever for inhibiting the bar from moving in a jaw-diverging direction unless the release lever is depressed. The lever is positioned for actuation by the foot so that considerable force may be applied as clamping action about the truck of the Christmas tree. The present apparatus provides a low profile linear horizontal clamping motion not found in the prior art and this has the advantages of being less obtrusive visually when in use and in less physical interference with surroundings.

A primary objective inherent in the above described apparatus and method of use is to provide advantages not taught by the prior art.

Another objective is to provide a foot actuated clamp for a Christmas tree.

A further objective is to provide such a clamping device which is operated within a basin or similar container which may be filled with water.

A still further objective is to provide such a clamping device having a linear horizontal motion so as to enable a low profile avoiding interference with low tree limbs and the like.

A yet further objective is to provide such a clamping device having plural clamping surfaces arranged in opposing positions and in vertically staggered formation.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present apparatus and method of it use. In such drawings:

FIG. 1 is a perspective view with partial cutaway of the presently described apparatus showing jaws of the apparatus in an open attitude;

FIG. 2 is a perspective view similar to that of FIG. 1, showing jaws of the apparatus in a closed attitude for clamping a Christmas tree or similar item;

FIGS. 3 and 4 are plan views analogous to FIGS. 1 and 2 respectively;

FIG. 5 is a sectional view taken along line 5-5 of FIG. 1 showing operating elements of a clamp actuator of the present apparatus;

FIG. 6 is a sectional view taken along line 6-6 of FIG. 1 showing operation of the clamp actuator for drawing jaws of the apparatus toward each other; and

FIG. 7 is a sectional view taken along line 7-7 of FIG. 1 showing operation of the clamp actuator for drawing jaws of the apparatus away from each other.

### DETAILED DESCRIPTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

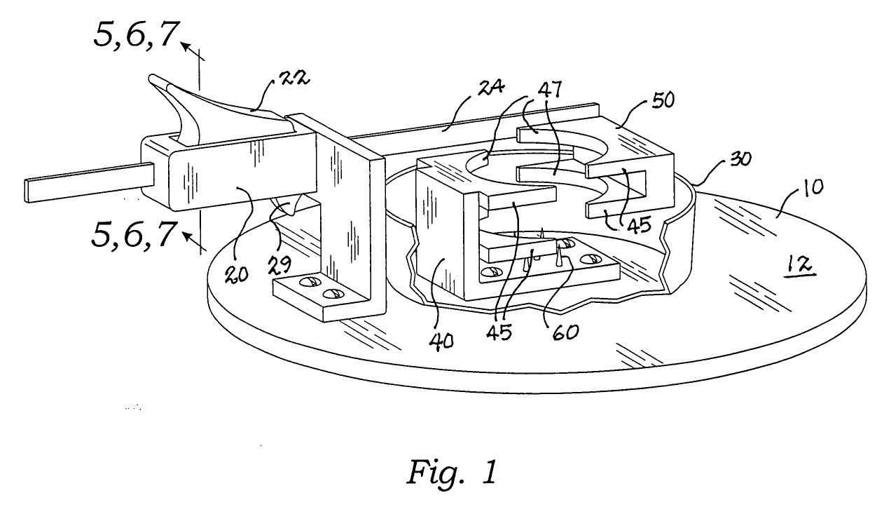

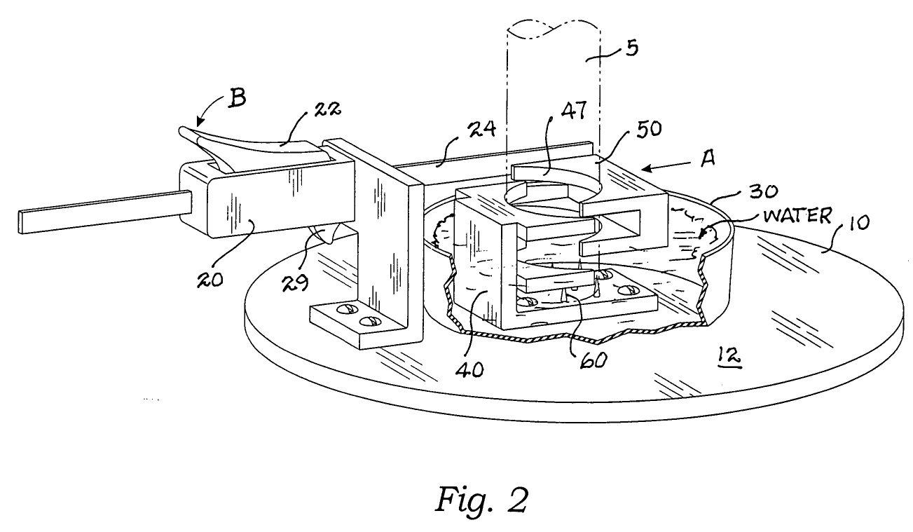

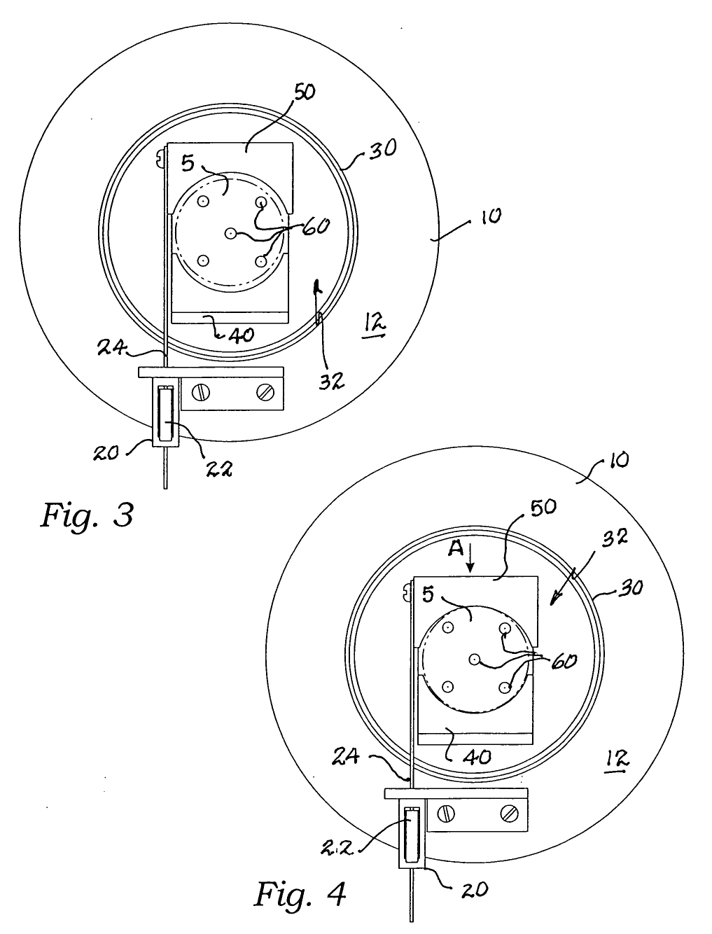

The presently described apparatus is preferably mounted on a platform 10 which is placed on a supporting surface, typically a floor surface. Engaged on an upwardly facing surface 12 of the platform 10 is (a) a linear clamp actuator 20, (b) a container 30 such as a basin, having an open top 32, and (c) a fixed jaw 40; as shown in FIGS. 1-4. A movable jaw 50 is engaged with the clamp actuator 20 by a linear bar 24 so as to be moved in linear horizontal motion toward the fixed jaw 40 in response to pumping action applied to a drive lever 22 of the clamp actuator 20. The fixed 40 and movable 50 jaws are positioned within the container 30. Preferably, an upwardly projecting penetration element 60, such as one or more spikes, as shown, are fixed to a bottom of the container 30 between clamping surfaces of the jaws 40 and 50. The bar 24 is slidably mounted within the clamp actuator 20 and enabled for horizontal movement of the bar 24 above and in parallel to the surface 12 of the platform 10. This is best shown in FIGS. 1 and 2. The fixed 40 and the movable 50 jaws may be made to vary their size, shape, angle, configuration in order to adapt to the shapes of various work pieces 5.

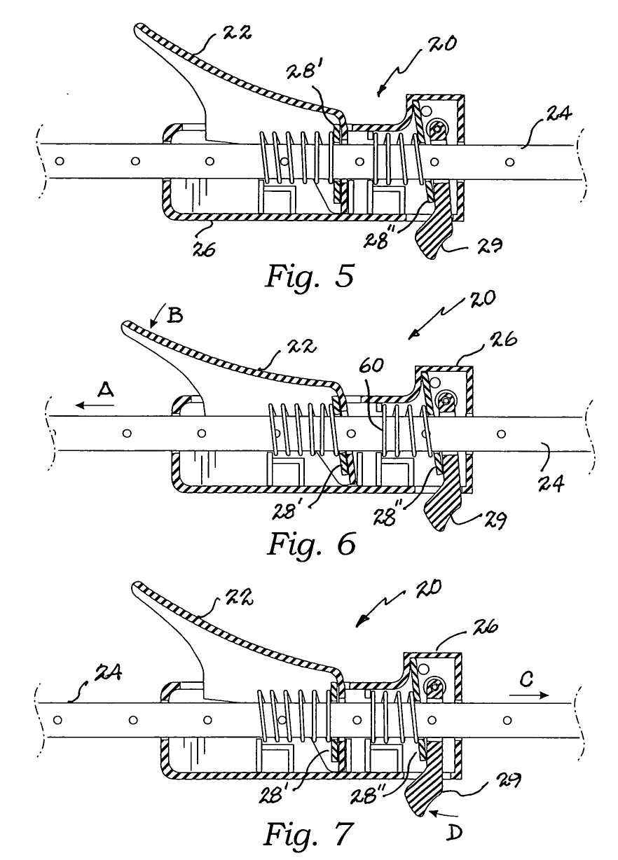

Referring now to FIGS. 5-7, the clamp actuator 20 provides a drive gate 28′ and a restrictor gate 28″. The drive gate 28′ is engaged with the bar 24 and the drive lever 22 for moving the bar 24 in a jaw-converging direction, shown by arrow “A” in response to a depression of the drive lever 22 as illustrated by arrow “B” in FIG. 6. Likewise, the restrictor gate 28″ is engaged with the bar 24 and a release lever 29 for inhibiting the bar 24 from moving in a jaw-diverging direction which is illustrated by arrow “C” in FIG. 7, unless the release lever 29 is depressed as illustrated by arrow “D” in FIG. 7. As shown in these figures, when bar 24 is moved in the direction shown by arrow “A”, bar 24 may tend to pull restrictor gate 28″ along with it, but in so doing, an aperture in the gate 28″ tends to provide greater clearance for bar 24 as the gate 28″ approaches a vertical stance, and spring 60 is compressed so as to prevent gate 28″ from passing through the vertical position which would further limit clearance of bar 24 through the aperture in gate 28″. When drive lever 22 is depressed, as shown in FIG. 6, is forces gate 28′ from a vertical position, as shown in FIG. 5, to a tilted position, as shown in FIG. 6, and this closes the clearance between an aperture in gate 28′ and bar 24 so that gate 28′ grips bar 24 pushing it in the direction of arrow “A” during each depression. When release lever 29 is depressed (arrow “D”), gate 28″ moves to a more vertical orientation and provides clearance for bar 24 to be manually moved in the direction of arrow “C”.

Referring now to FIGS. 1 and 2, we find that, preferably, the jaws 40 and 50, each have at least two clamping elements 45, wherein the clamping elements 45 are spaced vertically apart. Each of the clamping elements 45 preferably provide a semicircular clamping surface 47 and the clamping surfaces 47 of the fixed jaw 40 are in positional opposition to the clamping surfaces 47 of the movable jaw 50 and preferably vertically staggered so as to firmly grip the workpiece 5 (FIG. 2) without causing an unbalanced tipping moment.

In use, the described apparatus may be advantageously used for securing a Christmas tree in an upright attitude. As shown in FIG. 2, the movable jaw 50 is moved away from the fixed jaw 40 by pressing lever 29 and manually separating the jaws 40, 50. The trunk of tree 5 is placed into basin 30 pressing it against fixed jaw 40 and anchoring it into spikes 60. Next, lever 22 is depressed repeatedly thereby drawing the moving jaw 50 in the direction of arrow “A” until it contacts the tree trunk as shown. If the tree 5 is found to be not in a satisfactory vertical attitude, the lever 29 may be depressed and the movable jaw pulled away from the trunk slightly and then the tree 5 may be lifted off of the spikes 60, straightened, and then reengaged with the spikes 60. When this is completed, the tree 5 may again be clamped as before. Clearly, other workpieces may be advantageously clamped by the present apparatus so that it is not meant, herein, to infer that the present apparatus is only useful as a Christmas tree stand.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A clamping apparatus comprising: a platform for placement on a supporting surface; and engaged on a surface of the platform: a linear clamp actuator, a container having an open top, and a fixed jaw; a movable jaw engaged with the clamp actuator and enabled thereby to execute linear horizontal movement toward the fixed jaw in response to pumping action applied to a drive lever of the clamp actuator; the fixed and movable jaws positioned within the container.

2. The apparatus according to claim 1 further providing an upwardly projecting penetration element fixed to a bottom of the container between the jaws.

3. The apparatus according to claim 1 wherein the clamp actuator provides a linear bar slidably mounted within a lever housing for movement above and in parallel to the surface of the platform.

4. The apparatus of claim 3 wherein the clamp actuator provides, within the lever housing, a drive gate and a restrictor gate, the drive gate engaged with the bar and the drive lever for moving the bar in a jaw-converging direction in response to a depression of the drive lever, the restrictor gate engaged with the bar and a release lever for inhibiting the bar from moving in a jaw-diverging direction unless the release lever is depressed.

5. The apparatus of claim 1 wherein the jaws each have at least two clamping elements wherein the clamping elements are spaced vertically apart.

6. The apparatus of claim 5 wherein each of the clamping elements provide a semicircular clamping surface and the clamping surfaces of the fixed jaw are in positional opposition to the clamping surfaces of the movable jaw.

7. A clamping apparatus comprising: a clamp actuator; a fixed jaw immovably positioned; a movable jaw engaged with a sliding linear bar enabled for linear horizontal movement, to draw the movable jaw toward the fixed jaw in response to manual actuation such that the movable jaw approaches the fixed jaw to provide clamping action.

8. The apparatus of claim 7 wherein the clamp actuator provides, within a lever housing, a drive gate and a restrictor gate, the drive gate engaged with the bar and the drive lever for moving the bar in a jaw-converging direction in response to a depression of the drive lever, the restrictor gate engaged with the bar and a release lever for inhibiting the bar from moving in a jaw-diverging direction unless the release lever is depressed.

9. The apparatus of claim 7 wherein the jaws each have at least two clamping elements wherein the clamping elements are spaced vertically apart.

10. The apparatus of claim 9 wherein each of the clamping elements provide a semicircular clamping surface and the clamping surfaces of the fixed jaw are in positional opposition to the clamping surfaces of the movable jaw.
